(19) United States
(12) Patent Application Publication
(10) Pub. No.: US 2016/0059264 A1
(43) Pub. Date: Mar. 3, 2016

(54) USE OF PULSED THERMAL RADIATION AND NANO-STRUCTURES FOR THE EFFECTIVE GENERATION OF SOUND WAVES IN KHZ RANGE

(71) Applicant: JEJU NATIONAL UNIVERSITY INDUSTRY-ACADEMIC COOPERATION FOUNDATION, Jeju-si (KR)

(72) Inventors: Wongee CHUN, Jeju-si (KR); Seungjin OH, Jeju-si (KR); Namjin KIM, Jeju-si (KR); Youncheol PARK, Jeju-si (KR); Yeongmin KIM, Seogwipo-si (KR); Kuan CHEN, Salt Lake City, UT (US)

(21) Appl. No.: 14/471,854

(22) Filed: Aug. 28, 2014

(30) Foreign Application Priority Data
Aug. 28, 2014 (KR) 10-2014-0113020

(51) Int. Cl. B06B 1/00

(52) U.S. Cl. CPC B06B 1/00

(57) ABSTRACT

Disclosed herein is a high-efficiency kilohertz-range acoustic wave generator using a pulsed thermal radiation beam and a nanostructure. A nanorod unit having a high thermal expansion coefficient is provided behind a light interrupter so that the efficiency of generating acoustic waves can be enhanced. A pulse beam generated from the light interrupter is directly radiated onto the nanorod unit having a nanorod bundle structure with a nanorod-opposite-end support. Thermal deformation of the nanorod unit attributable to thermal expansion and contraction is repeated. In this way, the amplitude of sound waves can be increased, and relatively high decibel sound can thus be generated.

### BACKGROUND OF THE INVENTION

1. Field of the Invention

The present invention relates generally to acoustic wave generators in which a nanorod unit having a high thermal expansion coefficient is provided behind a light interrupter so that efficiency of generating acoustic waves can be enhanced. More particularly, the present invention relates to a high-efficiency kilohertz-range acoustic wave generator using a pulsed thermal radiation beam and a nanostructure configured such that: a pulse beam generated from a light interrupter is directly radiated onto a nanorod unit having a nanorod bundle structure with a nanorod-opposite-end support; and thermal deformation of the nanorod unit attributable to thermal expansion and contraction is repeated, whereby the amplitude of sound waves can be increased, and high decibel sound can thus be generated.

The present invention is configured to generate high-frequency (ultrasonic) waves from obtained acoustic waves and provide the acoustic waves for utilization in a variety of industrial fields including fields pertaining to sterilization, washing, etc.

2. Description of the Related Art

Generally, solar energy is used for air-conditioning or heating of buildings, lighting devices or power generation.

With regard to this, over the past half century studies on solar energy have been continuously conducted and many related techniques have already been commercialized. At present, various forms of solar energy conversion systems for improvement in efficiency are under study.

Meanwhile, the conversion of solar energy into acoustic energy, along with a solar tracking system, is opening a new chapter in technology using high-density solar energy. Most of this technology is focused on the development of thermoacoustic refrigerators.

Conventional thermoacoustic wave generators using solar light are configured such that a porous stack (solid block) is disposed in a transparent tube closed on one end thereof and thermoacoustic waves are generated by heating a portion thereof adjacent to the closed end of the transparent tube.

However, in conventional thermoacoustic wave generators, to generate high-frequency thermoacoustic waves, the size of the transparent tube must be reduced inversely proportional to the frequency of thermoacoustic waves, and a high thermal gradient between both ends of the porous stack must be maintained. Therefore, in practice it is very difficult to embody such conventional thermoacoustic wave generators. Referring to the result of research so far, it has been reported that the University of Utah, USA succeeded in producing a maximum acoustic wave of 3 kHz via this conventional technique.

In other words, it is no exaggeration to say that it is almost impossible to produce thermoacoustic waves in an ultrasonic wave range of 18 kHz or more using the above conventional technique.

Furthermore, research on generating thermoacoustic waves has focused on generating compression waves via a process of heating a very small micro-sized structure by momentarily applying Joule's heat resulting from electric energy to the structure and then cooling the structure. This process is repeated so that air surrounding the structure is expanded and cooled.

In an effort to overcome the problems of the conventional techniques pertaining to thermoacoustic wave generators, the applicant of the present invention proposed a thin metal plate membrane structure in Korean Patent Registration No. 10-1207380.

However, the technique of No. 10-1207380 is problematic in that the efficiency in producing high frequency is comparatively low because some solar light transmitted through a hole is lost in the air before it reaches the membrane structure. In addition, the size of a light interrupter must be greatly increased depending on the size of the thin metal plate. Therefore, it is substantially difficult to commercialize the technique.

### SUMMARY OF THE INVENTION

Accordingly, the present invention has been made keeping in mind the above problems occurring in the prior art, and an object of the present invention is to provide a high-efficiency kilohertz-range acoustic wave generator in which a nanorod unit having a high thermal expansion coefficient is provided behind a light interrupter so that efficiency of generating acoustic waves can be enhanced. The generator is also configured such that: a pulse beam generated from the light interrupter is directly radiated onto the nanorod unit having a nanorod bundle structure with a nanorod-opposite-end support; and thermal deformation of the nanorod unit attributable to thermal expansion and contraction is repeated, whereby the amplitude of sound waves can be increased, and relatively high decibel sound can thus be generated.

Another object of the present invention is to provide a high-efficiency kilohertz-range acoustic wave generator that is configured to generate high-frequency (ultrasonic) waves from obtained acoustic waves and provide the acoustic waves to a variety of industrial fields including fields pertaining to sterilization, washing, etc.

In order to accomplish the above object, the present invention provides a high-efficiency kilohertz-range acoustic wave generator using a pulsed thermal radiation beam and a nanostructure, including: a focusing tube focusing solar light collected by a solar tracking reflector to form high-density light and emitting the focused solar light; a light interrupter including a circular disk and a rotating drive unit, the circular disk having a plurality of holes arranged at positions spaced apart from each other at regular intervals in a circumferential direction around the rotating drive unit so that solar light emitted from the focusing tube passes through the holes and thus is intermittently emitted, and a pulse beam is formed by intermittent solar light that has passed through one of the holes of the light interrupter; a nanorod unit including a plurality of nanorod cells arranged without interfering with each other and configured such that the pulse beam passes in a direction perpendicular to linear bodies of the nanorod cells, the nanorod cells being thermally-expanded by pulse beams and thermally-contracted (repeatedly deformed), whereby the linear bodies of the nanorod cells micro-vibrate upward and downward, thus generating sound; and a nanorod-opposite-end support supporting opposite longitudinal ends of the nanorod unit.

Each of the nanorod cells of the nanorod unit may be made of a carbon nanotube or zinc oxide that has a high thermal expansion coefficient.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing the application of an acoustic wave generator according to the present invention; and

FIG. 2 is a view illustrating nanorod units according to the present invention.

### DESCRIPTION OF THE PREFERRED EMBODIMENTS

Hereinafter, the present invention will be described in detail with reference to the attached drawings.

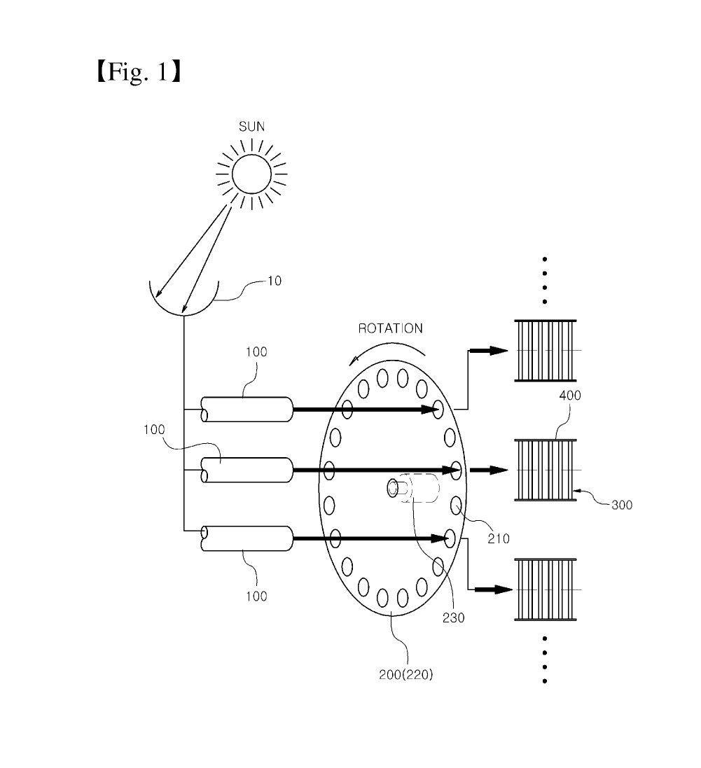

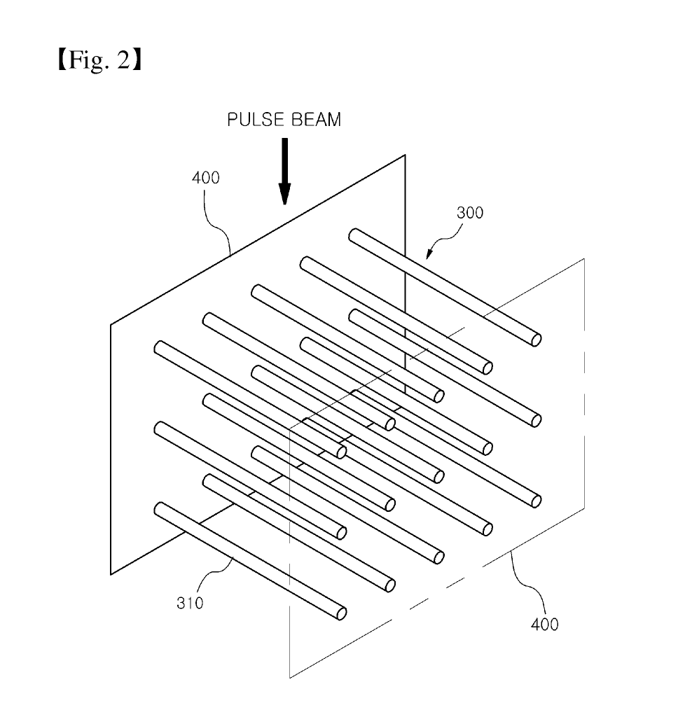

As shown in FIGS. 1 and 2, a high-efficiency acoustic wave generator according to the present invention includes a focusing tube 100, a light interrupter 200, a nanorod unit 300 and a nanorod-opposite-end support 400.

The focusing tube 100 focuses solar light collected by a solar tracking reflector to form high-density light and emits the focused light. The light interrupter 200 includes a circular disk 220 and a rotating drive unit 230. The circular disk 220 has a plurality of holes 210 arranged at positions spaced apart from each other at regular intervals in the circumferential direction around the rotating drive unit 230. Solar light emitted from the focusing tube 100 passes through the holes 210 so that the solar light is intermittently applied to the nanorod unit 300.

As shown in FIG. 1, the holes 210 formed at regular intervals around the perimeter of the circular disk 220 of the light interrupter 200 cause light to intermittently pass through the circular disk 220, thus making a pulse beam. Depending on the number of holes 210 and the RPM of the circular disk 220, the frequency of the pulse beam is determined.

The nanorod unit 300 includes a plurality of nanorod cells 310 arranged without interfering with each other and configured such that a pulse beam formed by intermittently passing solar light through the holes 210 of the light interrupter 200 passes in a direction perpendicular to the linear bodies of the nanorod cells 310. The nanorod cells 310 are thermally-expanded by pulse beams and thermally-contracted (repeatedly deformed), whereby the linear bodies of the nanorod cells 310 micro-vibrate upward and downward, thus generating sound.

That is, the nanorod unit 300 expands when light is applied thereto and contracts at the other times. In this way, the nanorod unit 300 micro-vibrates in conjunction with pulse beams.

The nanorod-opposite-end support 400 supports the opposite longitudinal ends of the nanorod unit 300 and fixes them in place.

Preferably, supporting and fixing the nanorod unit 300 using the nanorod-opposite-end support 400 is embodied by any one among a bonding method, a screw coupling method and a force fitting method.

It is preferable that only the end surfaces of the nanorod cells 310 of the nanorod unit 300 be fixed to the nanorod-opposite-end support 400 so that the vibration amplitude of each nanorod cell 310 can become sufficiently large.

Furthermore, the nanorod unit 300 is configured such that the nanorod cells 310 are arranged without longitudinally and laterally interfering with each other. Preferably, the nanorod cells 310 of the nanorod unit 300 are arranged such that the distance between the nanorod cells 310 is reduced from a side at which pulse beams enter the nanorod unit 300 to a side at which the pulse beams come out of the nanorod unit 300 so that the vibration performance of the nanorod unit 300 can be uniform over the entire area thereof.

Supporting the nanorod unit 300, the nanorod-opposite-end support 400 preferably has a container structure in which a side thereof at which pulse beams emitted from the holes of the light interrupter 200 enter the nanorod unit 300 is open and the other sides thereof are closed so that pulse beams can be directly transmitted to the nanorod unit 300 without leaking.

It is preferable that each nanorod cell 310 of the nanorod unit 300 be made of a carbon nanotube or zinc oxide having a high thermal expansion coefficient.

Furthermore, the nanorod unit 300 is preferably made of aluminum having a diameter ranging from 0.1 μm to 1 μm and is superior in a light absorption coefficient, a thermal expansion coefficient and heat radiation performance.

In addition, the container-shaped nanorod-opposite-end support 400 has a smaller diameter than that of a cross-sectional area of a solar light beam passing through one of the holes 210 of the light interrupter 200, whereby the thermal responsiveness can be maximized.

Preferably, the nanorod-opposite-end support 400 is coated with black to absorb as much solar light as possible.

Furthermore, the focusing tube 100 according to the present invention has a structure divided from the reflector into a plurality of focusing tubes 100, preferably, the number corresponds to the number of holes of the light interrupter 200. Connected to a converter, terminals (the nanorod units) respectively matching with the focusing tubes are disposed at a side opposite to the focusing tubes based on the light interrupter 200. A variety of wavelengths of light caused due to the characteristics of solar light are synchronized (integrated) with each other by the converter so that the output power is collected.

In other words, although electric energy generally has a single laser pulse wavelength, solar light has a variety of wavelengths of rays including infrared rays, ultraviolet rays, etc. Given this, when solar light is input to the terminals divided into several parts, a variety of wavelengths of light are collected by the converter, whereby the output power can be increased.

As described above, in a high-efficiency kilohertz-range acoustic wave generator using a pulsed thermal radiation beam and a nanostructure according to the present invention, a nanorod unit having a high thermal expansion coefficient is provided behind a light interrupter so that efficiency of generating acoustic waves can be enhanced. The generator is also configured such that a pulse beam generated from the light interrupter is directly radiated onto the nanorod unit having a nanorod bundle structure with a nanorod-opposite-end support, and thermal deformation of the nanorod unit attributable to thermal expansion and contraction is repeated. Thereby, the amplitude of sound waves can be increased, and relatively high decibel sound can thus be generated.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A high-efficiency kilohertz-range acoustic wave generator using a pulsed thermal radiation beam and a nanostructure, comprising:
a focusing tube (100) focusing solar light collected by a solar tracking reflector (10) to form high-density light and emitting the focused solar light;
a light interrupter (200) including a circular disk (220) and a rotating drive unit (230), the circular disk (220) having a plurality of holes (210) arranged at positions spaced apart from each other at regular intervals in a circumferential direction around the rotating drive unit (230) so that solar light emitted from the focusing tube (100) passes through the holes (210) and thus is intermittently emitted, and a pulse beam is formed by intermittent solar light that has passed through one of the holes (210) of the light interrupter;
a nanorod unit (300) including a plurality of nanorod cells (310) arranged without interfering with each other and configured such that the pulse beam passes in a direction perpendicular to linear bodies of the nanorod cells (310), the nanorod cells (310) being thermally-expanded by pulse beams and thermally-contracted (repeatedly deformed), whereby the linear bodies of the nanorod cells (310) micro-vibrate upward and downward, thus generating sound; and
a nanorod-opposite-end support (400) supporting opposite longitudinal ends of the nanorod unit (300).

2. The high-efficiency kilohertz-range acoustic wave generator as set forth in claim 1, wherein each of the nanorod cells (310) of the nanorod unit (300) is made of a carbon nanotube or zinc oxide that has a high thermal expansion coefficient.
